(19) United States
(12) Patent Application Publication
(10) Pub. No.: US 2004/0138038 A1
(43) Pub. Date: Jul. 15, 2004

(54) Adhesive strip as opening indicator

(76) Inventor: Philippe Eggermont, Champagne Sur Oise (FR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/703,972

(22) Filed: Nov. 6, 2003

(30) Foreign Application Priority Data
Nov. 7, 2002 (FR) 0213928

(51) Int. Cl. B31B 1/84

(52) U.S. Cl. 493/213

(57) ABSTRACT

Reclosable bag (1) comprising two walls (2, 3) forming a mouth (5) on which are fixed bag opening and closing means (8), an actuating slider (7) for the said means (8), means (6) forming opening indicator means, characterized in that the opening indicator means (6) comprise an adhesive strip bonded to an external surface of the opening and closing means (8) and of the actuating slider (7).

The invention likewise relates to a machine and a method of manufacture of such a bag.

### SUMMARY OF THE INVENTION

The present invention relates to plastic bags having an opening indicator.

More precisely, it relates to plastic bags having opening/closing profiles and a slider for manipulating the profiles and having an opening indicator.

### PRIOR ART

Numerous bags are known having opening indicators.

FIG. 1 shows schematically a first example of a bag 1 according to the prior art.

In FIG. 1, the bag has two substantially parallel sidewalls 2 and 3 forming the sides of the bag 1, the bag being closed at a lower end 4 and having an opening 5 opposite this closure 4.

The opening 5 permits access to the interior of the bag 1 during use. At the level of this opening 5, an opening indicator 6 is fixed, comprising a line of weakening 9 which is broken during the first use, thus constituting an opening indicator.

The bag 1 comprises complementary profiles 8 for opening and closing the bag 1.

A slider 7 permits actuating the opening and closing of the profiles.

Other examples of bags having opening indicators are likewise provided in the prior art.

FIG. 2 shows schematically another example of a bag having an opening indicator.

According to FIG. 2, the bag 1 likewise has substantially parallel sidewalls 2 and 3 forming the sides of the bag 1, and a mouth 5 opposite the bottom 4 of the bag.

The complementary opening and closing profiles 6 are always actuated by a slider 7.

In the example of FIG. 2, the opening indicator 6 is constituted by a film covering the mouth 5 and passing above the slider 7.

As in the example of FIG. 1, the opening indicator 6 comprises one or more lines of weakness 9. Each line of weakness 9 is closed when the bag is supplied to a user. It is broken during the first use.

Such an opening indicator is very practical for a user, who can easily know whether his bag has already been opened during purchase of the bag, for example.

However, bags according to the prior art are not completely satisfactory.

Indeed, the films 6 of FIGS. 1 and 2 forming opening indicators are difficult to fix to the bag walls, particularly because of the presence of the slider 7.

Moreover, positioning the films often requires the use of welding jaws. The jaws may at the same time damage the means 8, the walls 2 and 3, and the slider 7.

Finally, the films 6 are still present after opening the weakness means 9 and may thus be troublesome when the slider 7 is actuated and/or for access to the bag interior.

### SUMMARY OF THE INVENTION

The invention proposes remedying these disadvantages.

One of the objects of the invention is to propose a bag comprising opening indicator means which are not difficult to apply to the bag.

The application of the opening indicator should not damage the opening/closing means or the slider.

Another object of the invention is to propose opening indicator means which do not remain fixed to the bag after opening of the bag during first use.

For this purpose, the invention proposes a reclosable bag comprising two walls forming a mouth on which the bag opening and closing means are fixed, a slider for actuating the said means, and means forming opening indicator, characterized in that the opening indicator means comprise an adhesive strip adhered to an external surface of the opening and closing means and of the actuating slider, the strip having a width substantially equal to the width of the external surface of the opening and closing means, and of length substantially greater than that of the said means.

The invention likewise relates to a machine and to a method of manufacture of such a bag.

The invention is advantageously completed by the following characteristic:

it comprises at least one notch in at least an upper portion of the sidewalls, the notches facilitating access to an end of the adhesive strip.

### BRIEF DESCRIPTION OF THE FIGURES

Other characteristics, objects and advantages of the invention will become apparent from the following description, which is purely illustrative and non-limitative, and which should be read in conjunction with the accompanying drawings.

FIGS. 1 and 2, already commented on, show schematically two possible examples of bags according to the prior art and having opening indicators;

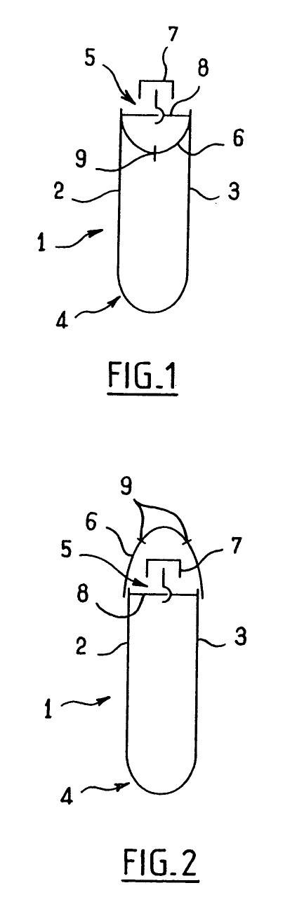

FIG. 3 shows schematically a possible method of manufacture of a bag according to the invention;

FIG. 4 shows the way in which the opening indicator means are removed from the bag manufactured by the method of FIG. 3.

### DETAILED DESCRIPTION

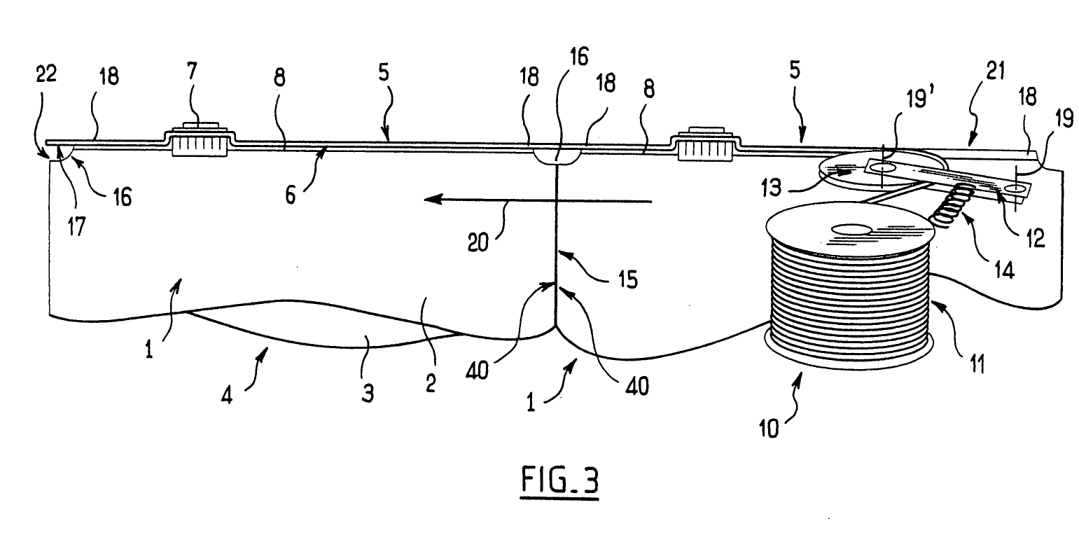

FIG. 3 shows schematically a set of bags 1 passing through a manufacturing machine 10.

As shown in FIG. 3, the present invention relates to the manufacture of reclosable bags on an automatic machine, these bags comprising opening indicator means.

The present invention may equally well be applied to machines for the automatic manufacture of bags passing through horizontally and to machines for the manufacture of bags passing through vertically.

Furthermore, the present invention is likewise applied to machines for automatic manufacture of bags with filling during a later stage of manufacture and if necessary separated geographically from the place of manufacture, at a single place and during successive steps.

The positioning of the opening indicator means could take place during a step after the filling of the bag, or before, in the case of filling by a side of the bag which does not have the said means.

In FIG. 3, the set of bags 1 is passing along in the direction of the arrow referenced 20, that is, from right to left in FIG. 3. The right-hand side is referenced by 21 and the left-hand side by 22.

Conventionally, the bags 1 comprise substantially parallel walls 1 and 3 forming the sides of the bags 1. The walls 2 and 3 are composed of one film or of two films, respectively folded or welded at the portion 4, which constitutes the lower portion of the bag 1.

The walls 2 and 3 are shown in section here, the portion situated near the bottom 4 of the bags not being shown in this Figure. They are conventionally composed of plastic. They can likewise be composed of composite material, such as a mixture of “plastic plus metallic film”, or even of materials of the type of paper or film on carton, for example.

A line 15, formed before the bags 1 pass through the machine 10 by conventional means known to one skilled in the art form a separation line between successive bags 1, and likewise separates their contents. Each line 15 defines the lateral edges 40 on both sides of the bags 1.

The line 15 may of course be formed by appropriate means after the bags have passed through the machine 10.

The portion forming the mouth 5 of the bags 1 comprises bag opening and closing means 8. The means 8 extend parallel to the mouth 5 and comprise, for example, complementary profiles, or profiles of the male/female type, or any other equivalent means. The means 8 are known to one skilled in the art and may comprise any of the means known to him, particularly opening indicators according to the prior art.

The opening or closing means 8 may arise from the material of the walls 2 and 3, or may be added to the walls. In the case in which the means 8 are added to the walls 2 and 3, the means 8 moreover comprise fixing films which permit joining them to the walls 2 and 3. The fixing films of the means 8 are conventionally fixed by bonding or welding to the walls 2 and 3.

The means 8 likewise comprise a slider 7 permitting opening and closing the means 8.

Generally, the slider 7 comprises a base plate having two flanges extending from it and a central rib. The flanges and the rib cooperate to form two non-parallel grooves which, according to the displacement direction of the slider, define convergent or divergent grooves. They thus permit closing or opening the complementary means 8. The slider 7 may be of metal or plastic, for example.

The means 8 advantageously comprise, at their longitudinal ends 18, a small weld to prevent the slider 7 slipping and escaping, for example by the end 22 of the through path. The ends 18 may comprise, as an alternative, means forming metallic rivets or any other equivalent means.

In the possible embodiment shown in FIG. 3, the bags 1, provided with their closing means 8 and their slider 7, arrive in line to pass through the machine from the side 21.

The machine 10 comprises means for fixing the means 6 forming an opening indicator onto the bags 1.

During the passage of the set of bags 1 in the machine 10, means 6 are positioned on at least one of the external surfaces of the means 8 and on at least one of the external surfaces of the slider 7.

Positioning comprises a step of bonding. The method of bonding can be any known method of bonding sufficiently powerful to prevent the displacement of the slider 7 on the means 8 before the first opening, but nevertheless not too strong, so that the strip 6 can be removed without damaging the means 8 and the slider 7.

The means 6 comprise, for example, an adhesive strip of width substantially equal to the width of the means 8, and whose length on an individualized bag 1 is substantially greater than the length of the means 8.

After passage of the bags 1 through the machine 10, the strip 6 covers an external surface of the means 8 and an external surface of the slider 7. It is thus impossible to displace the slider 7 and consequently to have access to the interior of the bag 1 without removing the opening indicator means 6.

The machine 10 comprises means for storage of the opening indicator means before positioning on the means 8.

It likewise comprises means capable of positioning and adhesion of the means 6 to the means 8 and the slider 7.

The storage means comprises, for example, a bobbin 11 on which the adhesive strip 6 is wound up. The strip 6 comprises on one of its surfaces means capable of adhering to the means 8 and to the slider 7.

The bobbin unwinds the strip 6 to a driving and bonding pulley 13 comprised in the means of positioning the strip 6.

The pulley 13 is capable of fixing the adhesive strip 6 to the means 8 and the slider 7. It comprises a disk which has on its edge a groove capable of guiding the strip 6 onto the means 8 and the slider 7. The mid-plane of the disk is perpendicular to the plane of passage of the bags 1 in the machine 10.

The link 12 principally comprises a rod connected on one side to a shaft 19′ passing through the center of the disk of the pulley 13 and on the other side to a shaft 19 substantially parallel to the walls 2 and 3 of the bags 1.

The pulley 13 is free to rotate around the shaft 19′ while the link 12 is movable in rotation around the shaft 19.

The spring means 14 control the movement of the link 12 around the shaft 19 while urging it against the means 8 and slider 7.

By the bias of the means 14, the pulley thus exerts a sufficient pressure for adhering the strip 6 to the means 8 and the slider 7.

The method of bonding thus has the tremendous advantage of not necessitating the use of welding jaws as in the case of the prior art films. Thus neither the means 8 nor the slider 7 are damaged.

The fact that the driving pulley 13 is actuated by a link 12 which is movable in a plane perpendicular to the plane of passage of the bags 1 has the result that the strip 6 may easily be bonded to the external wall of the means 8 and to the external wall of the slider 7, which are in different attitudes in this plane.

The bags are cut and welded at the end 22 in order to individualize them.

A user thus has only to grip an end 17 of the strip 6 to remove it, and thus to be able to open the bag 1.

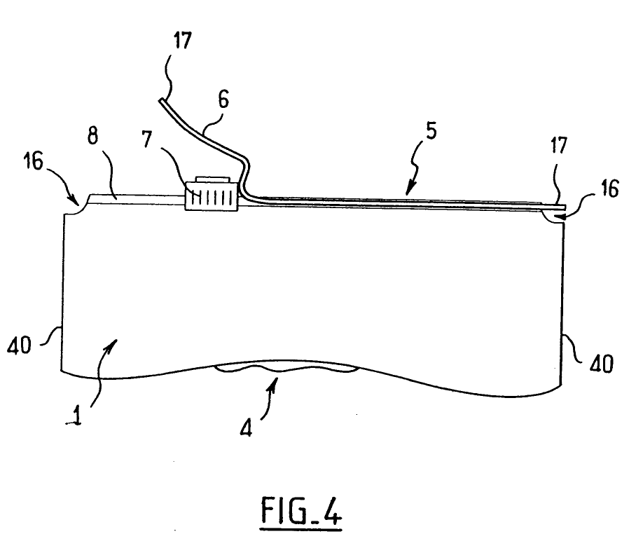

According to an advantageous alternative shown in FIGS. 3 and 4, the separations between the bags 1 situated at the intersection of the means 8 and the line 15 comprise a notch 16, for example a semicircular notch. The concavity of each notch is turned toward the top of the bag. The shape of the notch is convex toward the lower portion of the bag 1. As shown in FIG. 4, the notch thus starts from a lateral edge 40—resulting from the cutting and welding of a line of separation 15 of FIG. 3—and converges upward and toward the mouth 5 of the bag 1 to intersect the opening/closing means 8.

As shown in FIGS. 3 and 4, the notches 16 are preferably present on the two lateral edges of each bag 1. Thus the user may choose one or other of the lateral edges 40 to pull off the adhesive strip 6.

The notch 16 is capable of giving easier access to an end 17 of the strip 6 during a manipulation by a user.

Each notch 16 is formed by known plastic film perforating means and opening/closing means. The notch forming means are actuated to perform perforation on the lateral edges 40 of the bags, preferably before welding and cutting of the demarcation line 15.

FIG. 4 shows schematically the way in which the means 6 are removed during a first use.

The user easily has access to an end 17 of the means 8 by means of the notch 16 situated at the ends of the means 8, and can thus easily lift off the adhesive strip, which is thus released from the surface of the means 8 and slider 7. This permits freeing the actuation of the slider and opening the bag.

Advantageously, once the band is released, the strip cannot be re-bonded, so as to avoid a replacement of an opening indicator by a malicious person.

1. Reclosable bag (1) comprising two walls (2, 3) forming a mouth (5) on which are fixed opening and closing means (8), an actuating slider (7) for the said means (8), means (6) forming opening indicator means, characterized in that the opening indicator means (6) comprise a strip bonded to an external surface of the opening and closing means (8) and of the actuating slider (7), the strip (6) having a width substantially equal to the width of the external surface of the opening and closing means (8), and a length substantially greater than that of the said means (8) so as to define at least one end (17) capable of being gripped by a user.

2. Bag according to claim 1, characterized in that it comprises at least one notch (16) in at least one upper portion of the lateral walls (40), the notches (16) being capable of facilitating access to an end (17) of the adhesive strip (6).

3. Machine for manufacturing reclosable bags having two walls (2, 3) forming a mouth (5) on which are fixed means (8) for opening and closing the bag, a slider (7) for actuating the said means (8), means (6) forming opening indicator means, characterized in that it comprises means capable of fixing to an external surface of the opening and closing means (8) and of the slider (7) for actuating the opening indicator means (6) comprising an adhesive strip (6) of width substantially equal to the width of the external surface of the opening and closing means (8), and length substantially greater than that of the said means (8), in order to define at least one end (17) capable of being gripped by a user.

4. Machine according to claim 3, characterized in that it comprises means for storing the adhesive strip (6).

5. Machine according to claim 4, characterized in that the storage means comprise a bobbin (11).

6. Machine according to one of claims 3-5, characterized in that it comprises means capable of fixing the strip onto the opening and closing means (8) and onto the slider (7).

7. Machine according to one of claim 6, characterized in that the strip fixing means comprise a pulley (13) in the form of a disk comprising a groove receiving the adhesive strip (6), the pulley being actuated against the opening/closing means (8) and the slider by a link (12) pressed by spring means (14).

8. Machine according to claim 7, characterized in that the link (12) principally comprises a rod connected on the one hand to a shaft (19′) passing through the center of the disk of the pulley (13) and on the other hand to a shaft (19) substantially parallel to the walls (2, 3) of the bags (1).

9. Machine according to one of claims 3-8, characterized in that it comprises means capable of forming at least one notch (16) in the upper portion of at least one of the lateral edges of the bags (1).

10. Method of manufacture of a reclosable bags having two walls (2, 3) forming a mouth (5) onto which are fixed bag opening and closing means (8), a slider (7) for actuating the said means (8), means (6) forming an opening and closing indicator, characterized in that it comprises the steps according to which:
the bag being formed and having the opening and closing means of the bag (1) and their slider is caused to pass through;
an adhesive strip (6) forming an opening indicator is bonded to an external surface of the opening/closing means (8) and of the slider (7), the said strip is of width substantially equal to the width of the external surface of the opening and closing means (8) and of length substantially greater than that of the said means (8), in order to define at least one end (17) capable of being gripped by a user.

11. Method according to claim 10, characterized in that it comprises a step according to which a notch (16) is formed on at least one lateral edge (40) of the bag (1) and capable of facilitating access to an end (17) of the adhesive strip.
